(19) United States
(12) Patent Application Publication
(10) Pub. No.: US 2022/0162835 A1
(43) Pub. Date: May 26, 2022

(54) SYSTEM AND METHOD FOR STATUS RECOGNITION OF A COMPONENT OF A WORKING MACHINE AND WORKING MACHINE

(71) Applicant: LIEBHERR-MCCTEC ROSTOCK GMBH, Rostock (DE)

(72) Inventors: Reinhard Vilbrandt, Kritzmow (DE); Martin Seifert, Rostock (DE)

(21) Appl. No.: 17/456,521

(22) Filed: Nov. 24, 2021

(30) Foreign Application Priority Data
Nov. 26, 2020 (DE) 10 2020 131 333.0

(51) Int. Cl. E02F 9/26; B66C 13/18; E02F 9/22

(52) U.S. Cl. CPC E02F 9/267; E02F 9/2203; E02F 9/261; B66C 13/18

(57) ABSTRACT

The disclosure relates to a system for recognizing a status of a component of a working machine comprising a working machine, a memory communicating with the control unit, and an analysis means connected to the control unit. The working machine has at least one element movable by a drive and a control unit by means of which the drive is controllable. At least one active characteristic for the control of the drive of the working machine is stored in the memory. In accordance with the disclosure, the control unit is configured to determine a control parameter for the control of the drive in dependence on a desired parameter that relates to a movement of the drivable element of the working machine with reference to an active characteristic.

### CROSS REFERENCE TO RELATED APPLICATION

The present application claims priority to German Patent Application No. 10 2020 131 333.0 filed on Nov. 26, 2020. The entire contents of the above-listed application is hereby incorporated by reference for all purposes.

### TECHNICAL FIELD

The present disclosure relates to a system for recognizing a status of a component of a working machine comprising a working machine, in particular a crane or an excavator, a memory, and an analysis means, a method of recognizing a status of a component of a working machines, and a working machine.

### BACKGROUND

In a large number of working machines such as mobile cranes or hydraulic excavators, the control of the hydraulic hoisting gear or other hydraulic gear takes place with the aid of stored characteristics or maps. A desired speed for a hoisting gear can, for example, be converted into a current value for the control of the drive or of the hydraulic pilot control of the drive of the hoisting gear with the aid of such characteristics or maps, with e.g. non-linear progressions of the hydraulic system being taken into account. If a plurality of characteristics are provided for different values of further parameters such as the temperature or the payload, maps or families of characteristics are spoken of.

The characteristics or maps are here stored in the working machine and are typically set or adapted manually in the factory or on the test bench, for example after a component change or after a longer operating time. The replacement or the servicing of the components controllable via the characteristics typically takes place after a failure or after an elapse of a predefined time duration. A failure of a component has the consequence of an unplanned downtime of the working machine and thus of high consequential costs. On the other hand, on a routine replacement or servicing of the components after the elapse of a fixed time interval, the components are not necessarily already in need of replacement (unnecessary replacement), do not require any servicing (unnecessary servicing) or have already failed.

### SUMMARY

It is therefore the object of the present disclosure to improve the availability of the components of such working machines and to avoid unnecessary component changes and service work.

This object is achieved in accordance with the disclosure by a system. Embodiments of the disclosure result from the following description.

A system for recognizing a status of a component of a working machine is accordingly proposed that comprises a working machine, in particular a crane or an excavator, a memory in communication with the control unit, and an analysis means connected to the control unit. The working machine has at least one element movable by a drive and a control unit by means of which the drive is controllable. At least one active characteristic for the control of the drive of the working machine is saved or stored in the memory

In accordance with the disclosure, the control unit is configured to determine with reference to an active characteristic a control parameter for the control of the drive in dependence on a desired parameter that relates to a movement of the drivable element of the working machine. The analysis means is furthermore adapted in accordance with the disclosure to compare at least one active characteristic with at least one inactive characteristic and to draw a conclusion on a status of a component of the working machine on the basis of this comparison. Not only an active characteristic can be compared with an inactive characteristic in this process. The complete history or at least a plurality of characteristics that are then correspondingly compared can also be recorded to estimate the component status.

The component can be any desired component serving the control of the movable element, for example the drive of the element itself or a part of the drive system such as a valve or a valve or a pilot valve.

The inactive characteristic here serves as a reference characteristic that permits a conclusion on a status of the corresponding component by a comparison with the active characteristic used for the control. The status of the component can thus already be estimated before a failure or before a fixed service point in time and corresponding measures can be taken in real time. Conversely, a replacement or a servicing is only carried out when it is necessary due to the estimated status. Unnecessary component changes or service work are thereby avoided. Such a need-based and targeted service results in a better availability of the working machine since the change or the repairs can be planned better and do not only have to take place on a complete component failure.

The comparison of the active and inactive characteristics in particular takes place automatically so that the effort for the operator is reduced and a monitoring of the component status takes place that is as free of gaps as possible. However, this does not preclude the operator or an action planning office from initiating a targeted status recognition. The status recognition of drive systems such as hydraulic systems or their components in the field is improved overall without additional tools and additional analyses.

Strictly speaking, the determination of the control parameter is a determination of the value of the control parameter. The same applies to the desired parameter whose value is used as the basis for the determination of the value of the control parameter. For reasons of simplicity, however, simply only the desired parameter and the control parameter is spoken of in the present case. The same applies in a relationship described further below with the detection of the value of an actual parameter that is simply called a detection of the actual parameter in the present case.

The characteristic can be a single characteristic in the literal sense, a portion of a map or of a family of characteristics comprising a plurality of individual characteristic lines or a multidimensional map or family of characteristics. An active map can thus also be compared with an inactive map.

The drive can be a hydraulic motor or a hydraulic cylinder. The drive can be pilot controlled, for example via an actuator or a valve, but can be directly controlled. The pilot control may take place electrically, i.e. the control parameter is in particular an electrical parameter such as a current value. The control parameter can furthermore be a variable, i.e. what is here called a control of the drive can be a regulation.

The memory can be arranged in the working machine. The memory can alternatively be part of an external processor unit or cloud that is in particular wirelessly in communication with the control unit of the working machine.

The control unit can carry out the comparison between an active and an inactive characteristic and/or the recognition of a status of the corresponding component directly locally in the working machine. It is alternatively conceivable that the required data of the working machine are transmitted to an external processing unit or cloud, in particular wirelessly, or that they are already available and the comparison between the active and inactive characteristic and/or the status determination is carried out externally by the processor unit or cloud. Provision can be made in the latter case that the at least one active characteristic stored locally in the memory of the working machine is transmitted to the external processing unit that then carries out the comparison with an inactive characteristic stored, for example, at a reference point in time.

Provision is made in a possible embodiment that the inactive characteristic is a characteristic that is not usable or is not used for determining the control parameter at the point in time of the comparison with the active characteristic and therefore only serves as a reference for the comparison for the purpose of the status recognition. The inactive characteristic relates to the same component or to a component of the same type as the active characteristic so that the comparison of the active and inactive characteristics permits a direct conclusion on the status of said component.

Provision is made in a further possible embodiment that the inactive characteristic was generated at an earlier point in time (=reference point in time) than the active characteristic. The active characteristic can be changed or adapted at least once with respect to the inactive characteristic. The inactive characteristic in particular relates to the same component as the active characteristic.

In this case, the inactive characteristic may be a characteristic used for the control on the delivery of the working machine, that is on the first putting into operation, whereas the active characteristic was changed or adapted at least once with respect to the inactive characteristic in the course of the previous overall operating time of the working machine, in particular in response to a change of the characteristic values or operating points of the component to which the characteristic relates.

The active characteristic that was adapted or optimized at least once takes account of changes of the characteristic values of the characteristic that result, for example, from the aging of the component (e.g. increased leakage), from wear, from a component replacement, a component repair, or other disturbances. The adaptations of the characteristic values therefore directly reflect these changes/disturbances of the operating points of the component and enable a conclusion on its current status.

It can naturally occur that the active characteristic has been adapted or set multiple times in comparison with the inactive characteristic serving as the reference value. In this case, either only the first inactive characteristic (e.g. the characteristic valid at the point in time of the first delivery of the working machine) can be stored as the reference. Alternatively, each of the characteristics produced or adapted in the meantime can be stored so that a plurality of reference characteristics are available. A more exact or time resolved picture of the status change can result from this that enables a better estimate of the instantaneous status and of the history of the component.

Provision can alternatively be made that the inactive characteristic was produced at a later point in time than the active characteristic. In other words, the active characteristic is still used for the control, whereas an adapted or optimized new characteristic was generated and stored at least once as an initially inactive characteristic. This inactive characteristic that was generated later is used for the comparison and for the status recognition and can optionally be used instead of the earlier active characteristic for the control at a specific point in time by “switching over”. This conversion can take place during operation (or in one of the downtimes) or e.g. as part of a component replacement indicated by the status recognition.

Due to the later generation, the inactive characteristic takes account of changes of the characteristic values of the characteristic that result, for example, from the aging of the component (e.g. increased leakage), from wear, from a component replacement, a component repair, or other disturbances. The changes of the characteristic values therefore directly reflect these changes/disturbances and enable a conclusion on the current status of the component. However, the control still takes place at the point in time of the comparison via the active characteristic that is not adapted to the last changes/disturbances.

Provision can alternatively or additionally be made that the inactive characteristic was produced with respect to a component, in particular a component of the same type, of another working machine. With sufficiently large populations of working machines of the same construction or that are comparable (reference group), the characteristics used for the control of the other working machines (that is the “active” characteristics of the other working machines) serve as inactive characteristics or reference characteristics for the working machine looked at here. It is likewise conceivable that the inactive characteristics generated or stored with respect to other working machines also serve as inactive characteristics for the working machine looked at here or were generated at different life cycle times of the other working machines.

Such a comparison with other working machines enables the recognition of general peculiarities of the component in comparison with the reference group. A reliable statement can furthermore already be given with respect to the status of the observed component after a short life cycle and therefore also with a smaller separate database of the observed working machine.

To be able to ideally estimate the status of the component, a combination can also be provided, that is a comparison of the active characteristic with an inactive characteristic generated at an earlier or later point in time and a comparison with characteristics of other working machines. In this respect, general peculiarities or differences in comparison with the reference group can also be recognized in addition to time changes of the behavior of the component.

Provision is made in a further possible embodiment that the active characteristic is a manually generated characteristic, that is in particular a characteristic generated or adapted in the factory or on a test bench by an operator or a characteristic generated automatically by means of an adaptive system. The adaptive system is in particular implemented in the working machine itself and may be able to respond independently to changes of the operating points or characteristic values of the components and to generate correspondingly adapted characteristics that are then used as active characteristics. An autonomous status recognition of the component is thereby made possible without a manual setting of the characteristics necessarily being required for the comparison of the characteristics underlying the status recognition. A manual generation of new active characteristics can naturally be possible at any time, however.

The inactive characteristic can also be a set characteristic, for example a characteristic set in the factory before the first delivery.

Provision is made in a further possible embodiment that the analysis means is provided or performable in the working machine or in an external processor unit communicating wirelessly with the working machine. In the former case, the analysis means can be part of the control unit of the working machine or can be performed by it. In the latter case, the calculations for the determination of the status of the component are carried out outside the working machine and the results or the corresponding data are transmitted to the working machine.

Provision is made in a further possible embodiment that the analysis means is adapted to take account of operating information of the working machine in the determination of the status, said operating information relating to a component replacement, a component repair or servicing, a number of movement procedures or cycles, a time duration since a last preparation or setting of a characteristic, and/or a time duration since a putting into operation of the working machine. This operating information is in particular regularly recorded and/or transmitted from an external processing unit to the working machine. Deployment times, load cycles, and environmental conditions such as the temperature are recorded in a manner accompanying the service life and are taken into account in the status recognition. This enables a detailed evaluation and interpretation of the characteristic changes resulting from the comparison and thereby a reliable statement on the status of the component.

Provision is made in a further possible embodiment that the analysis means is adapted to take account of environmental information such as the temperature that is detectable by means of at least one sensor device on the determination of the status, with the environmental conditions being detectable by means of the sensor device at regular intervals or on certain events such as the performance of a specific movement or the starting of the working machine during the operating duration of the working machine.

Provision is made in a further possible embodiment that the status of the component determined by the analysis means relates to an aging or to wear of the component and/or that the analysis means is adapted to draw a conclusion on a remaining time period, in particular a remaining residual lifetime of the component, or on a number of movement procedures or cycles on the basis of the comparison between the active and inactive characteristics. This forecast with respect to a remaining residual lifetime or a number of cycles can be considered a “determination of a status of the component”. Not only an actual status of the component starting from past changes of the characteristics is therefore determined, but a statement or forecast is also made on the future, i.e. in particular on a residual lifetime to be expected or a remaining number of movement cycles.

Provision is made in a further possible embodiment that the analysis means is adapted to carry out the determination of the status of the component at regular intervals or on specific events during the operation duration of the working machine. The status recognition or the comparison between the characteristics can in this respect be carried multiple times within individual operating phases, i.e. between the respective downtimes, of the working machine. Provision can likewise be made that the status recognition or the comparison between the characteristics is detected at fixed points in time (e.g. once per day/week/month, etc.) or on certain events, for example on the starting of the working machine.

Provision is made in a further possible embodiment that the working machine comprises a measuring device by means of which an actual parameter relating to a movement of the drivable element is detectable, with the control being configured to recognize a difference with reference to a comparison between an actual and a desired parameter and to adapt an active characteristic or to generate an adapted inactive characteristic on the basis of this difference. Changes of the characteristic values or operating points of the component can therefore be corrected in real time and automatically by means of this adaptive system.

In this respect, an active characteristic is either directly changed and adapted or optimized or an inactive adapted characteristic is first generated. In the former case, the comparison for the status recognition takes place between adapted active characteristics and inactive characteristics prepared earlier. In the latter case, a comparison takes place between the initially unchanged active characteristics and the newly prepared, adapted inactive characteristics.

Differences of the characteristic values of the controlled system can be recognized and evaluated in real time by the comparison of the measured actual parameter with the predefined desired parameter and by the dynamic adaptation of a stored adapted characteristic or by a generation of a new adapted characteristic. Changes of the characteristic values, for example due to aging phenomena, after a component replacement, or due to element tolerances, can thereby be compensated and the control can thereby be improved.

Provision is made in a further possible embodiment that the control unit is configured to generate at least one active or inactive characteristic in a calibration mode by a targeted control of the drive and a sequential detection of a plurality of values of the actual parameter during the movement of the element, with the calibration mode being actuable manually and/or automatically. In the calibration mode, test drives are carried out in a targeted manner and measurement data of the actual parameter are detected to carry out an adaptation or a new generation of the characteristics.

Provision is made in a further possible embodiment that the drive is a hydraulic drive that is in particular pilot controllable via a hydraulic actuator, with the control parameter being a current value for the control of the drive or of the actuator and/or with the desired parameter relating to a speed. In this respect, the drive and/or the actuator can represent the component whose status is determined on the basis of the comparison with the inactive characteristic. The movable element can be a hoisting gear.

The preceding statements naturally also apply to embodiments in which a plurality of drives are controllable simultaneously and separate characteristics or maps are provided for each drive.

The desired parameter can be predefinable by an operator input of the operator of the working machine. It is likewise conceivable that the desired parameter is stored in a memory and/or table and/or is itself determined or calculated, for example on the basis of an operator input. The case should be mentioned by way of example here that the operator of a crane triggers a raising of a load by an operator input, with the lifting speed being determined by the control unit with reference to stored tables and further operating parameters such as the payload, the crane configuration, or the like.

The present disclosure further relates to a working machine, in particular a crane or excavator, having at least one element movable by a drive, wherein the working machine comprises a control unit, a memory, and an analysis means of the system in accordance with the disclosure. The analysis means and the memory are therefore part of the working machine. The same properties otherwise obviously result as for the system in accordance with the disclosure so that a repeat description will be dispensed with at this point. The possible embodiments described with respect to the system apply analogously to the working machine in accordance with the disclosure.

The present disclosure further relates to a method of recognizing a status of a component of a working machines of the system in accordance with the disclosure, the method comprising the following steps:

comparing an active characteristic that is used for determining a control parameter for the control of a component of the working machine with an inactive characteristic that relates to the same component or to a comparable component; and determining a status of the controllable component based on the comparison between an active and inactive characteristic.

In this respect, the active and inactive characteristics may differ from one another by at least owe adaptation having been carried out, i.e. the active characteristic was either adapted at least once in comparison with the inactive characteristic or vice versa. Alternatively or additionally, the inactive characteristic represents a characteristic of another working machine that is of the same construction or is comparable.

In this respect, the same properties obviously result as for the system or for the working machine in accordance with the disclosure so that a repeat description will be dispensed with at this point. The possible embodiments described with respect to the system apply analogously to the method in accordance with the disclosure.

Provision is made in a possible embodiment, of the method that the following steps are furthermore carried out:

detecting an actual parameter by means of a measuring device, with the actual parameter relating to a movement of the drivable element of the working machine and with its control taking place with reference to an active characteristic while taking account of a desired parameter;

comparing the actual parameter and the desired parameter;

recognizing a difference between the actual parameter and the desired parameter; and

generating an inactive or an active characteristic on the basis of the difference recognized.

The comparison between the actual and the desired parameters, the recognition of the difference or the corresponding analysis, and/or the generation of the characteristic can be carried out by means of the control unit of the working machine or by means of an external processing unit or cloud.

Provision can be made that the actual parameter is detected multiple times after one another during the operating duration of the working machine and is compared with the desired parameter, with an active characteristic being dynamically adapted during operation or a new inactive characteristic being generated and/or an inactive characteristic being adapted.

### BRIEF DESCRIPTION OF THE FIGURES

Further features and details of the disclosure result from the embodiments explained in the following with reference to the Figures. There are shown:

FIG. 1: a schematic representation of the method in accordance with the disclosure in accordance with a first embodiment; and

FIG. 2: a schematic representation of the method in accordance with the disclosure in accordance with a second embodiment.

### DETAILED DESCRIPTION

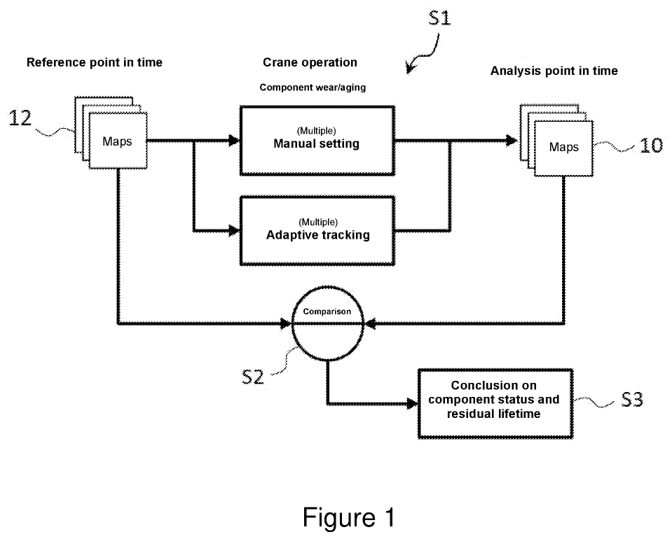

FIG. 1 schematically shows a first embodiment of the status recognition in accordance with the disclosure on the basis of a characteristic comparison. The status recognition will be described in the following for the example of a crane. The disclosure is, however, not restricted to cranes, but can be used with any desired working machines.

In the embodiment shown in FIG. 1, a crane mechanism or a hoist winch for lifting a load via a hydraulic drive is controlled. The drive is pilot controlled via a hydraulic valve, with the valve being electronically controlled via a control unit of the crane or via a crane control. Active maps 10 for the implementation of a desired speed in the hoisting gear is stored in a memory of the working machine, said maps 10 being used for the determination of a corresponding current value for the control of the drive. The active maps 10 here take account of the partially non-linear characteristics of the hydraulic system (e.g. valve characteristics).

The maps 10 can be grouped with reference to measurable parameters such as temperature, payload, or torque, etc. A specific active map 10 is used for the determination of the current value in dependence on the temperature and the load to be raised, for example. This determination can takes place, for example, by means of interpolation between discrete characteristic values. Individual characteristics can also be stored and correspondingly grouped alternatively to maps.

In known systems, the hydraulic cranes are manually set on the test bench (i.e. current values are fixed for the valves and characteristics are prepared). The setting takes place as a rule here with respect to the maximum speeds to be reached (e.g. maximum speed of the hoisting gear). After a component replacement (abrupt change in the system) or after a longer operating time (aging of the components), the crane has to be reset or adapted characteristics have to be generated. The time change of the maps over the service life of the crane here corresponds to the use of the reserves of the hydraulic system or to the required compensation of the wear/aging of the components.

In the solution in accordance with the disclosure, a permanent systematic comparison of maps with a direct relationship now takes place. If, for example, a higher current value for reaching the same maximum speed or desired speed is required than at an earlier point in time, this signifies an increased hydraulic oil leak in the hydraulic drive system of the hoisting gear, which in turn results from advanced component wear or aging phenomena.

For this purpose, the active maps 10 of the crane that are currently used to control the components of the drive system and that are stored in a memory of the crane are compared with inactive maps 12 that were prepared at an earlier point in time (reference point in time). It can here in particular be the point in time of delivery of the crane. If the maps had been manually set or adapted on the test bench (1st alternative of step S1) or automatically adaptively adapted (2nd alternative of step S1) since the delivery (reference point in time) due to the change of the operating points or characteristic values of the drive system (for example due to aging or component replacement), these adapted active maps 10 reflect the aging or wear of the drive system.

An analysis means that can be implemented or performed in the crane control or in an external processor can draw a conclusion on the current status (e.g. aging status or wear status) of the drive system (step S3) by a comparison of the adapted or compensated active maps 10 with the original and now inactive maps 12 at the reference point in time (S2). In this respect, in particular recorded deployment times, load cycles, component changes, and environmental parameters such as the temperature are included.

It is furthermore possible not only to reproduce e.g. the previous aging process, but also to make forecasts for the future. Statements can e.g. be made on the residual lifetime of the drive system to be expected or of the components controlled via the maps (e.g. valves) or remaining movement cycles to be expected until a replacement or a servicing is necessary.

This status recognition and forecast or extrapolation can be carried out while accompanying the life cycle and thus deliver indications of component damage to be expected and of actually necessary servicing intervals. Repairs thereby become better plannable (“predictive maintenance”) and the machine availability is increased.

The adaptation of the active maps 10 (step S1) can take place via an automatic adaptive tracking while accompanying the life cycle. For this purpose, the actual speeds of the hoisting gear (for example the turning speed of the hoist winch or the speed of the pulling means or of the pull rope) are measured via a measuring device, are provided to the crane control, and are compared with the desired parameters (that represent the input parameters of the maps). The maps are automatically adapted as a result of recognized deviations. The control is thereby improved and simultaneously new active maps 10 are provided for the comparison underlying the status recognition.

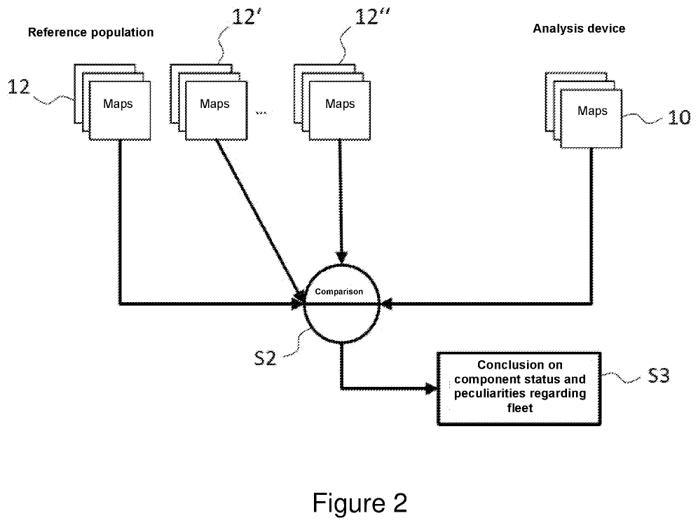

FIG. 2 shows an alternative embodiment in which the active maps 10 of the crane (analysis device) are not compared with previous (inactive) maps of the same machine, but rather with maps 12, 12′, 12″ of other cranes that are of the same construction or are comparable (reference units) (step 2) and a conclusion is drawn from this on the status of the components of the drive system (step S3). This can in particular be considered with sufficiently large populations of such machines that are of the same construction or are comparable and that form a reference group. General peculiarities of the components of the hydraulic system or drive system are then also identifiable alternatively to or in addition to a time aging. This comparison can be carried out using characteristics of other cranes at different life cycle times. The maps 12, 12′, 12″ of the reference population represent inactive maps with respect to the analysis unit.

### REFERENCE NUMERAL LIST

10 active map
12 inactive map
12′ inactive map
12″ inactive map
S1 adaptation of a characteristic
S2 comparison between inactive and active characteristics
S3 determination of a status of the controllable component

1. A system for recognizing a status of a component of a working machine comprising:
the working machine having at least one element movable by a drive and a control unit by means of which the drive is controllable;
a memory in communication with the control unit in which at least one active characteristic for the control of the drive of the working machine is stored; and
an analysis means connected to the control unit,
wherein
the control unit is configured to determine a control parameter for the control of the drive in dependence on a desired parameter relating to the movement of the element with reference to an active characteristic; and
the analysis means is adapted to compare at least one active characteristic with at least one inactive characteristic and to draw a conclusion on the status of the component of the working machine on the basis of this comparison.

2. The system in accordance with claim 1, wherein the inactive characteristic is a characteristic that is not usable for determining the control parameter at a point in time of the comparison with the active characteristic.

3. The system in accordance with claim 2, wherein the inactive characteristic was generated at an earlier or later point in time than the active characteristic and/or with respect to a component of another working machine that is of the same type.

4. The system in accordance with claim 1, wherein the active characteristic is a characteristic generated manually or automatically by means of an adaptive system.

5. The system in accordance with claim 1, wherein the analysis means is provided in the working machine or in an external processor unit communicating wirelessly with the working machine.

6. The system in accordance with claim 1, wherein the analysis means is adapted to take account of operating information of the working machine in the determination of the status of the component.

7. The system in accordance with claim 6, wherein the analysis means is adapted to take account of environmental information that is detectable by means of at least one sensor device on the determination of the status.

8. The system in accordance with claim 2, wherein the status of the component determined by the analysis means relates to an aging or to wear of the component; and/or in that the analysis means is adapted to draw a conclusion on a remaining time period.

9. The system in accordance with claim 6, wherein the analysis means is adapted to carry out the determination of the status of the component at regular intervals or on specific events during the operation duration of the working machine.

10. The system in accordance with claim 8, wherein the working machine comprises a measuring device by means of which an actual parameter relating to a movement of a drivable element is detectable, with the control unit being configured to recognize a difference with reference to a comparison between an actual and a desired parameter and to adapt an active characteristic or to generate an adapted inactive characteristic on the basis of this difference.

11. The system in accordance with claim 10, wherein the control unit is configured to generate at least one active or inactive characteristic in a calibration mode by a targeted control of the drive and a sequential detection of a plurality of values of the actual parameter during the movement of the element, with the calibration mode being manually and/or automatically actuable.

12. The system in accordance with claim 1, wherein the drive is a hydraulic drive that is pilot controllable via a hydraulic actuator, with the control parameter being a current value for the control of the drive or of the actuator and/or with the desired parameter relating to a speed.

13. A working machine having at least one element movable by the drive, wherein the working machine comprises the control unit, the memory, and the analysis means of a system in accordance with claim 1.

14. A method of recognizing a status of a component of a working machine of a system in accordance with claim 10, the method comprising the steps:
comparing an active characteristic that is used for determining a control parameter for the control of a component of the working machine with an inactive characteristic that relates to the same component or to a comparable component; and
determining a status of the component based on the comparison between an active and inactive characteristic, wherein the component is controllable,
wherein the active and inactive characteristics differ from one another by at least one adaptation, and/or wherein the inactive characteristic represents a characteristic of another working machine that is of the same construction or is comparable.

15. The method in accordance with claim 14, with the following steps furthermore being carried out:
detecting the actual parameter by means of the measuring device of the working machine, with the actual parameter relating to the movement of the drivable element of the working machine and with its control taking place with reference to the active characteristic while taking account of the desired parameter;
comparing the actual parameter and the desired parameter;
recognizing the difference between the actual parameter and the desired parameter; and
generating the characteristic on the basis of the difference recognized.

16. The system in accordance with claim 1, wherein the working machine is a crane or excavator.

17. The system in accordance with claim 8, wherein the analysis means is adapted to draw a conclusion on a residual lifetime of the component, or on a remaining number of movement procedures on the basis of the comparison between the active and inactive characteristics.

18. The system in accordance with claim 2, wherein the inactive characteristic relates to the same component or to a component of the same type.

19. The system in accordance with claim 6, wherein the operating information relates to a component replacement, a component repair, a number of movement procedures, a time duration since a last preparation or setting of a characteristic, and/or a time duration since a putting into operation of the working machine.

20. The system in accordance with claim 7, wherein the environmental information is detectable by means of the sensor device at regular intervals or on certain events during an operating duration of the working machine.
